(19) United States
(12) Patent Application Publication
(10) Pub. No.: US 2005/0158213 A1
(43) Pub. Date: Jul. 21, 2005

(54) Microfluid system

(76) Inventors: Hidekazu Tsudome, Ryugasaki (JP); Takehiko Kitamori, Tokyo (JP); Kiichi Sato, Tokyo (JP); Manabu Tokeshi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,673

(22) Filed: Jan. 5, 2005

(30) Foreign Application Priority Data
Jan. 15, 2004 (JP) 2004-007604

(51) Int. Cl. B01L 3/00

(52) U.S. Cl. 422/100

(57) ABSTRACT

In a microfluid system it is intended to expand the application range of samples capable of being treated, decrease the amount of samples used, and prevent deterioration of samples with the lapse of time. In a microfluid system having a microchip for feeding plural samples to a treating portion and performing predetermined treatments, plural sample servers for storage of the samples therein are provided in the microchip, the sample servers and the treating portion are connected with each other through capillary channels provided respectively on outlet sides of the sample servers, and a pressurizing device for pressurizing the samples stored in the sample servers and feeding them to the treating portion is provided.

### CLAIM OF PRIORITY

The present application claims priority from Japanese application serial JP 2004-007604 filed on Jan. 15, 2004, the content of which is hereby incorporated by reference into this application.

### FIELD OF THE INVENTION

The present invention relates to a microfluid system. Particularly, the present invention is suitable for a microfluid system provided with a sample treating portion in a microchip.

### BACKGROUND OF THE INVENTION

An integration technique for carrying out a chemical reaction within a very small space is now being noted from the standpoint of high speed of the chemical reaction and also from the standpoint that the reaction and analysis are performed in a very small amount of a sample. In a microchemical system using a microchip which is one of integration techniques for chemical reactions, there are formed an inlet for introducing samples into the microchip and a microchannel connected to the inlet, and within the microchannel there are performed such sample treatments as reaction, separation, extraction, detection, mixing, synthesis, and analysis. As examples of reactions performed in the microchemical system there are mentioned diazotization reaction, nitration reaction, and antigen-antibody reaction. As examples of extraction and separation there are mentioned solvent extraction, electrophoresis separation, and column separation.

As a conventional microfluid system there has been proposed an electrophoresis system for analyzing a very small amount of proteins and nucleic acid. Such a system is disclosed, for example, in Japanese Patent Laid-Open No. H8(1996)-178897 (Patent Literature 1).

In the electrophoresis system disclosed in Patent Literature 1, a first substrate and a second substrate are bonded together to form an integrated plate member, and a sample analyzing groove provided with a buffer reservoir portion and a sample pouring groove are formed in both end portions of the first substrate, while in the second substrate a through hole is formed at the position opposed to the buffer reservoir portion formed in the first substrate and an electrode film for the application of voltage is formed on an inner wall of the through hole and also in the vicinity of both surfaces of the through hole. In this electrophoresis system, a connection is made through the electrode film to a high voltage power supply installed in the body of the electrophoresis system and voltage is applied to effect migration.

According to another microfluid system so far proposed, a syringe pump or a roller pump is used to transport samples to a microchip without being influenced by the properties of the samples. For example, such a microfluid system is disclosed in Japanese Patent Laid-Open No. 2003-114229 (Patent Literature 2).

The microchip used in the measuring system disclosed in Patent Literature 2 has a very small, first channel for the passage therethrough of a sample, a very small, second channel for the passage therethrough of a labeled substance, a very small reaction channel formed by joining of both the first and second channels, and a reaction site provided in the reaction channel and to which a specific coupling substance is fixed. A syringe pump is connected through a silicon tube to the first and second channels in the microchip and a sample and a labeled substance are fed from the syringe pump.

[Patent Literature 1]

Japanese Patent Laid-Open No. H8(1996)-178897

[Patent Literature 2]

Japanese Patent Laid-Open No. 2003-114229

### SUMMARY OF THE INVENTION

In Patent Literature 1, since an electrophoresis method is used as a sample transporting method, the fluids capable of being handled by this electrophoresis method are limited to such aqueous solutions as can migrate upon application of voltage. It has so far been impossible to handle such samples as nonpolar organic solvents.

In Patent Literature 2, since the silicon tube which connects the sample transporting syringe pump to the microchip is a much larger channel than the very small channels formed in the microchip, it has so far been required to use a large amount of samples sufficient to fill up the interior of a tube which provides a connection from a pump discharge port up to a sample inlet of the mircrochip. Further, since the retention time of samples within the tube is long, there has been a fear that the sample quality may be deteriorated with the lapse of time.

It is an object of the present invention to provide a microfluid system capable of expanding the application range of samples for treatment, decreasing the amount of samples used, and preventing deterioration of samples with the lapse of time.

According to the present invention, for achieving the above-mentioned object, there is provided a microfluid system having a microchip for feeding plural samples to a treating portion and performing predetermined treatments, wherein plural sample servers for storage of the samples therein are provided in the microchip, the sample servers and the treating portion are connected with each other through capillary channels provided respectively on outlet sides of the sample servers, and a pressurizing device for pressurizing the samples stored in the sample servers and feeding them to the treating portion is provided.

In connection with the above construction, the following constructions are more preferred.
(1) The microchip is constituted by a microchip body and a sample holder in an up-and-down relation to each other, the treating portion is formed in the microchip body, and the sample servers are formed in the sample holder.
(2) The capillary channels are formed so as to have a surface tension such that the samples stored in the sample servers do not flow out by their own weights.
(3) A sample inlet portion for introducing samples from the sample servers, a channel inlet portion for introducing samples from the sample inlet portion to the treating portion, and a channel separating portion extending from the treating portion, are formed in the microchip body.
(4) The pressurizing device comprises a flexible member for closing openings formed in the sample servers, the flexible member being brought into deformation into the sample servers to pressurize the samples.
(5) The sample servers are provided so as to be open in an upper surface of the sample holder, and the flexible member is formed in the shape of a thin plate and is installed on the sample holder so that it can close and open the openings of the sample servers.
(6) At least one of the microchip and the pressurizing device is made movable for separation from and close contact with each other.
(7) The pressurizing device applies a fluid pressure to the flexible member on the side opposite to the sample servers, causing the flexible member to be deformed into the sample servers.
(8) A positioning means is provided for positioning the sample holder and the microchip body so as to provide communication between the sample servers and the treating portion.
(9) The treating portion and the sample servers are provided in plural sets.

According to the microfluid system of the present invention, when the interiors of the sample servers are pressurized, samples can be fed to the treating portion from the sample servers through the capillary channels and it is possible to expand the application range of samples capable of being treated, decrease the amount of samples used and prevent deterioration of samples with the lapse of time.

### BRIEF DESCRIPTION OF THE DRAWINGS

FIG. 1 is a construction diagram of a microfluid system according to a first embodiment of the present invention;

FIG. 2 is an explanatory perspective view of a microchip body used in the microfluid system of FIG. 1;

FIG. 3 is a vertical sectional view of a microchip and a sample holder;

FIG. 4 is a central sectional view of FIG. 3;

FIG. 5 is a vertical sectional view of a principal portion of a microfluid system according to a second embodiment of the present invention;

FIG. 6 is a vertical sectional view of a principal portion of a microfluid system according to a third embodiment of the present invention;

FIG. 7 is a vertical sectional view of a principal portion of a microfluid system according to a fourth embodiment of the present invention; and

FIG. 8 is a perspective view of a microchip body used in a microfluid system according to a fifth embodiment of the present invention.

### DETAILED DESCRIPTION OF THE PREFERRED EMBODIMENTS

Plural embodiments of the present invention will be described hereinunder with reference to the accompanying drawings. In the following embodiments, the same reference numerals represent the same or equivalent portions.

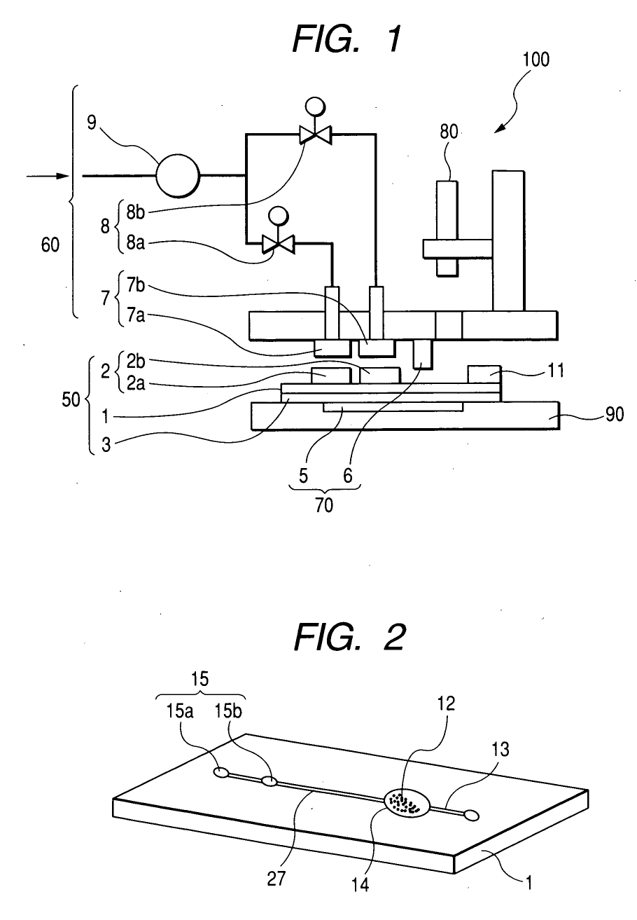

A microfluid system according to a first embodiment of the present invention will be described below with reference to FIGS. 1 to 3.

An entire construction of the microfluid system, indicated at 100, of this first embodiment will be described below with reference to FIG. 1. FIG. 1 is a construction diagram of the microfluid system of this first embodiment.

The microfluid system 100 includes a microchip 50, a pressurizing device 60, a temperature controller 70, a treatment state detector 80, and a stage 90. Treatments performed in the microfluid system 100 include sample reaction, separation, extraction, detection, mixing, synthesis, and analysis. Examples of the reaction include diazotization reaction, nitration reaction, and antigen-antibody reaction. Examples of the extraction and separation include solvent extraction and column separation.

The microchip 50 includes a microchip body 1, a sample holder 2, a drain 11, and a base 3. The sample holder 2 comprises plural sample holders, which are a first sample holder 2a and a second sample holder 2b in the illustrated example. The microchip body 1 is fixed by being held grippingly between the base 3 and the first sample holder 2a, second sample holder 2b, and drain 11.

The microchip 50 is placed on the stage 90 which is movable vertically. As the stage 90 moves vertically, the microchip 50 is also moved vertically. By raising the stage 90, the first and second sample holders 2a, 2b are brought into close contact with a lower surface of the pressurizing device 60 (more specifically, lower surfaces of a first pressurizing portion 7a and a second pressurizing portion 7b). By lowering the stage 90, a space is formed between the first and second sample holders 2a, 2b and the pressurizing device 60.

The drain 11 is for the storage of samples after the reaction performed within the microchip body 1 and is in communication with an outlet side of a channel separating portion 13. A liquid absorbing member or a fluid outlet port may be provided within the drain 11 to discharge the samples after the reaction to any other place than the system of the present invention.

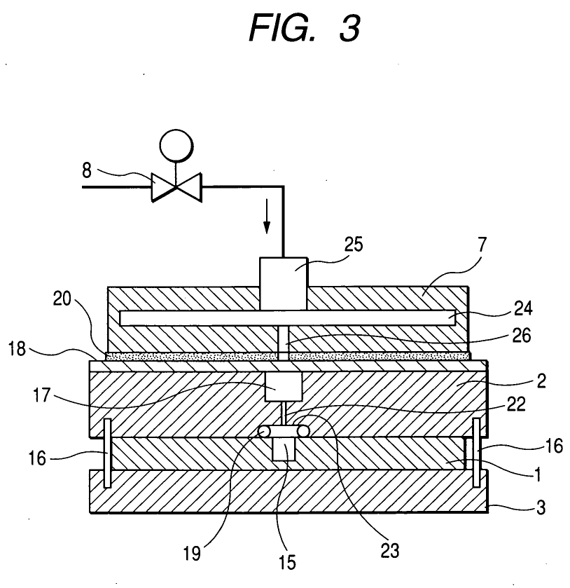

The pressurizing device 60 includes a flexible member 18 (see FIG. 3), a pressurizing portion 7, a pressure control valve 8, and a pressurizing fluid regulator 9. The pressurizing portion 7 is made up of plural pressurizing portions corresponding to the sample holders 2. In the illustrated example, the pressurizing portion 7 is made up of a first pressurizing portion 7a and a second pressurizing portion 7b. The pressurizing portion 7 is for applying a pressurized fluid, e.g., pressurized air or any other gas, to the flexible member 18.

The pressure control valve 8 is made up of plural pressure control valves provided respectively in channels to the plural pressurizing portions 7. In the illustrated example, the pressure control valve 8 is made up of a first pressure control valve 8a and a second pressure control valve 8b provided respectively in channels to the first pressurizing portion 7a and the second pressurizing portion 7b. The pressure control valves 8 are constituted by electromagnetic opening/closing valves and the supply of fluid to the first and second pressurizing portions 7a, 7b is controlled by opening and closing the valves.

The pressurizing fluid regulator 9 is for making adjustment so that the pressure of the fluid to be fed to the pressurizing portions 7 can be changed as desired.

The temperature controller 70 includes a heater 5 and a temperature sensor 6. The heater 5 is provided for controlling the sample temperature to a temperature necessary for performing treatments such as reaction, extraction, and separation within the microchip 50. The heater 5 is disposed between the microchip body 1 and the stage 90. For example, a Peltier element is used as the heater 5, having a heating or cooling function.

The temperature sensor 6 is for detecting the temperature of the microchip 50. More particularly, it is for detecting a surface temperature of the microchip body 1. On the basis of the result of the measurement performed by the temperature sensor 6 the heater 5 is controlled to control the temperature of the microchip body 1 to a predetermined temperature necessary for sample treatment.

More specifically, a temperature regulator (not shown) is connected to the temperature sensor 6 to control the supply of electric power for the heater 5.

The temperature sensor 6 is installed at a position above and away from the heater 5. As the stage 90 rises, the temperature sensor 6 comes into contact with a surface of the microchip body 1, permitting the measurement of temperature. When a spring or the like is attached to the temperature sensor 6, the temperature sensor 6 is pushed against the surface of the microchip body 1 by means of the spring, whereby the temperature detection can be done positively. According to another installation method for the temperature sensor 6, the temperature sensor 6 is installed on a surface of the heater 5 to measure a temperature of the microchip body 1.

The treatment state detector 80 is used for measuring the state after reaction in a chemical system provided within the microchip body 1. A moving mechanism for moving the treatment state detector 80 to a desired measurement position above the microchip 1 may be provided.

Next, a concrete construction of the microchip body 1 will be described below with reference to FIG. 2. FIG. 2 is an explanatory perspective view of the microchip body used in the microfluid system of FIG. 1.

The microchip body 1 is formed in the shape of a plate using such a material as glass, silicon, or resin. The microchip body 1 shown in the illustrated example is of the type used in a microfluid system using a microchip for immunological analysis. The microchip body 1 includes a microchip reaction vessel portion 14 containing fine solid particles of 1 mm or less in diameter as a reaction solid phase and a channel separating portion 13 having a sectional area whose width is smaller than the diameter of the fine solid particles 12. The microchip reaction vessel portion 14 constitutes a treating portion.

The microchip body 1 includes plural microchip sample inlet portions 15, which are in the illustrated example a microchip labeled antibody inlet portion 15a for introducing a labeled antibody as a first sample into the microchip reaction vessel portion 14 and a microchip antigen inlet portion 15b for introducing an antigen as a second sample into the microchip reaction vessel portion 14. The labeled antibody inlet portion 15a and the antigen inlet portion 15b are in communication with the microchip reaction vessel portion 14 through a channel inlet portion 27.

In FIG. 2 there is shown only one set comprising the microchip reaction vessel portion 14, the microchip antigen inlet portion 15b, and the microchip labeled antibody inlet portion 15a. Plural such sets may be provided in parallel. Further, plural microchip inlet portions 15 may be provided according to the type of sample necessary for the reaction or the number of times of sample introduction.

Next, with reference to FIG. 3, a description will be given below about a concrete construction of the microchip 50 and that of the pressurizing device 60. FIG. 3 is a vertical sectional view of the microchip and the sample holder. The sample holders 2a and 2b are of the same structure and so are the pressurizing portions 7a and 7b, so that, in FIG. 3, even in case of only one of the sample holders or of the pressurizing portions, it will be indicated by the generic name numeral concerned.

The sample holder 2 is formed using a material having chemicals resistance to the sample treated or a material not exerting any bad influence on the sample treated, e.g., PEEK material, glass, or polycarbonate. Plural positioning pins 16 are installed so as to straddle the sample holder 2 and the base 3. The positioning pin 16 located on one side is brought into abutment against a side end portion of the microchip body 1, whereby the microchip body 1 and the sample holder 2 are aligned with each other and the microchip body 1 is sandwiched in between the sample holder 2 and the base 3. The positioning pins 16 may be substituted by a positioning groove formed in the base 3 and the microchip body 1 may be aligned with the positioning groove.

A sample server 17 is formed within the sample holder 2 so that an upper surface thereof is open. The size of the sample server 17 is set at a size proportional to a required amount of samples to be distributed. Although in this embodiment the sample server 17 is in the shape of a circular cylinder, the shape thereof may be, for example, an elliptic cylinder or the like. A capillary channel 22 of 1 mm or less in diameter is formed on an outlet side of the sample server 17, whereby the sample server 17 and the microchip reaction vessel portion 14 are connected to each other through the capillary channel 22. Under a surface tension induced by the capillary channel 22, the sample charged into the sample server 17 stays within the sample server without leakage insofar as it is placed under the atmospheric pressure.

The capillary channel 22 is open to a holder sample discharge port 23 which is formed as a shallow recess in a lower surface of the sample holder 2. The holder sample discharge port 23 confronts and communicates with the microchip sample inlet portion 15. A packing. 19 is installed within the holder sample discharge port 23 and is crushed in between the sample holder 2 and the microchip body 1 when the stage 90 is raised and samples are fed. Thus, the holder sample discharge port 23 and the microchip inlet portion 15 are connected together in a hermetically sealed manner, so that there is no possibility of sample leakage. Further, by setting the inside diameter of the packing 19 larger than the size of the microchip inlet portion 15, it is possible to introduce samples positively into the microchip 1 even when the holder sample discharge port 23 and the microchip inlet portion 15 are positionally deviated from each other due to a fabrication tolerance.

The flexible member 18 is provided so as to close the upper opening of the sample server 17. More specifically, the flexible member 18 is formed in the shape of a thin plate and is installed removably on an upper surface of the sample holder 2 so that it can open and close the opening of the sample server 17. By thus installing the flexible member 18 to the sample holder 2 after sample distribution to the sample server 17, it is possible to prevent mixing of foreign matters into the sample server 17.

The pressurizing portion 7 is formed with a central space 24 into which a pressurizing fluid is introduced. A pressurizing fluid inlet portion 25 is in communication with an upper surface of the central space 24, while a pressurizing fluid discharge port 26 is in communication with a lower surface of the central space 24. A packing 20 is provided on a lower surface of the pressurizing portion 7. In the packing 20 is formed a hole communicating with the pressurizing fluid discharge port 26. The packing 20 is provided to prevent the leakage of fluid when the pressurizing fluid discharged from the central space 24 of the pressurizing portion 7 to the pressurizing fluid discharge port 26 pressurizes the flexible member 18. The packing 20 may be used in common with the flexible member 18.

When the flexible member 18 is pressurized with the pressurizing fluid by the pressurizing portion 7, the flexible member 18 is deformed and the sample distributed to the sample server 17 are pressurized thereby, so that the sample is discharged in a very small amount from the capillary channel 22. When the sample is distributed to the sample server 17 in only such an amount as is required in the chemical system which performs treatments with use of the microchip 50, all the sample is used up in a single chemical reaction and hence there is no fear of deterioration of the sample even with the lapse of time.

When the flexible member 18 is formed using a material of a high elongation percentage such as natural rubber, polyurethane, or silicone rubber, and when the material selected has a thickness of 0.5 mm or less, the flexible member 18 can be deformed easily with air or any other gas introduced from the pressurizing portion 7. That is, when the flexible member 18 is pressurized, the flexible member expands toward the sample server 17, so that the sample pre-distributed to the sample server 17 is extruded and can be introduced easily into the microchip 1 by the microchip inlet portion 15 provided in the microchip body 1.

Further, when the pressure of the fluid for operating the flexible member 18 is changed arbitrarily by the pressuring fluid regulator 9 shown in FIG. 1, the pressurizing portion 7 can control the inlet pressure to a desired pressure at the time of introducing a sample in the sample server 17 into the microchip 1 through the flexible member 18, and the amount of sample introduced per unit time can be controlled with a high accuracy. Besides, since the pressurizing portion 7 is of a differential pressure type, even such samples as nonpolar organic solvents can also be introduced into the microchip 1 and therefore the sample application range can be expanded in comparison with the electrophoresis type.

Since the sample present within the sample server 17 and the fluid used in the pressurizing portion 7 are shut off from each other by the flexible member 18, the fluid does not mix into the sample.

Further, the distance of the channel from the sample server 17 to which the sample is distributed up to the microchip inlet portion 15 is short and the channel is formed by the capillary channel 22. Accordingly, it is no longer required to use such a tube as in the prior art for connection between the sample server and the microchip inlet portion and hence a large amount of sample necessary for filling up the interior of the tube is no longer required. Therefore, the deterioration of sample with the lapse of time caused by the staying of the sample within the tube can also be prevented.

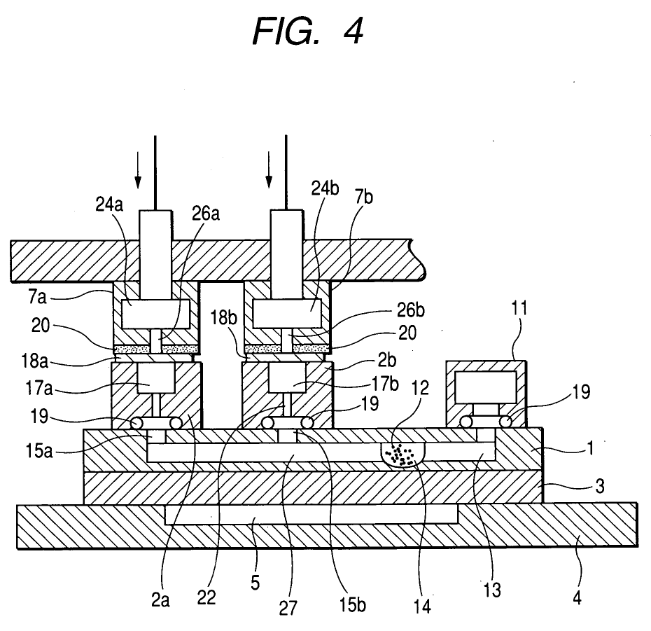

Next, the operation of the microfluid system will be described below with reference to FIG. 4. FIG. 4 is a central sectional view of FIG. 3, showing in what state each sample is treated.

In a state in which the pressurizing portion 7 does not pressurize the flexible member 18 with fluid, each sample within the sample server 17 stays within the sample server without being introduced into the microchip inlet portion 15.

In this state, when the first pressure control valve 8a opens, allowing fluid to be fed to the first pressurizing portion 7a, and a fluid pressure is applied to the flexible member 18a so as to operate the flexible member 18a downward, the flexible member 18a is deformed and the antigen present within the first sample server 17a in the first sample holder 2a is introduced into the microchip antigen inlet portion 15a. At this time, on the basis of the relation between the pressurizing force of the first pressurizing portion 7a and a pressure loss induced by an internal channel shape of the microchip body 1, when the pressurizing force is made large, the amount of liquid introduced per unit time into the microchip antigen inlet portion 15a can be made large, while when the pressurizing force is made small, the amount of liquid introduced per unit time into the microchip antigen inlet portion 15a can be made very small.

When the downward operation of the flexible member 18a is continued, the flexible member 18a comes into abutment against the bottoms of the sample servers 17a, whereupon the flexible member 18a is no longer deformed even under continued pressurization with the fluid in the first pressurizing portion 7a.

The antigen introduced at this time is fed to the microchip reaction vessel portion 14, but tends to advance also toward the second sample holder 2b. However, since the second sample server 17b in the second sample holder 2b is closed with the flexible member 18b and the packing 20 on an upper surface of the flexible member 18b is open only in the range of the very small hole, the flexible member 18b cannot move upward. Therefore, the antigen never advances toward the second sample holder 2b.

Then, when the second pressure control valve 8b opens, allowing fluid to be fed into the second pressurizing portion 7b, and a fluid pressure is applied to the flexible member 18b so as to operate the flexible member 18b downward, the flexible member 18b is deformed and the labeled antibody present within the second sample server 17b in the second sample holder 2b is introduced into the microchip labeled antibody inlet portion 15b. The labeled antibody introduced at this time is fed to the microchip reaction vessel portion 14, but tends to advance also toward the first sample holder 2a. However, since the flexible member 18a which closes the first sample server 17a in the first sample holder 2a is continued to be pressurized by the first pressurizing portion 7a, the labeled antibody never advances toward the first sample holder 2a.

The antigen and labeled antibody thus introduced into the microchip reaction vessel portion 14 react over the fine solid particles 12, then unreacted portions are separated in the channel separating portion 13 and are stored in the drain 11.

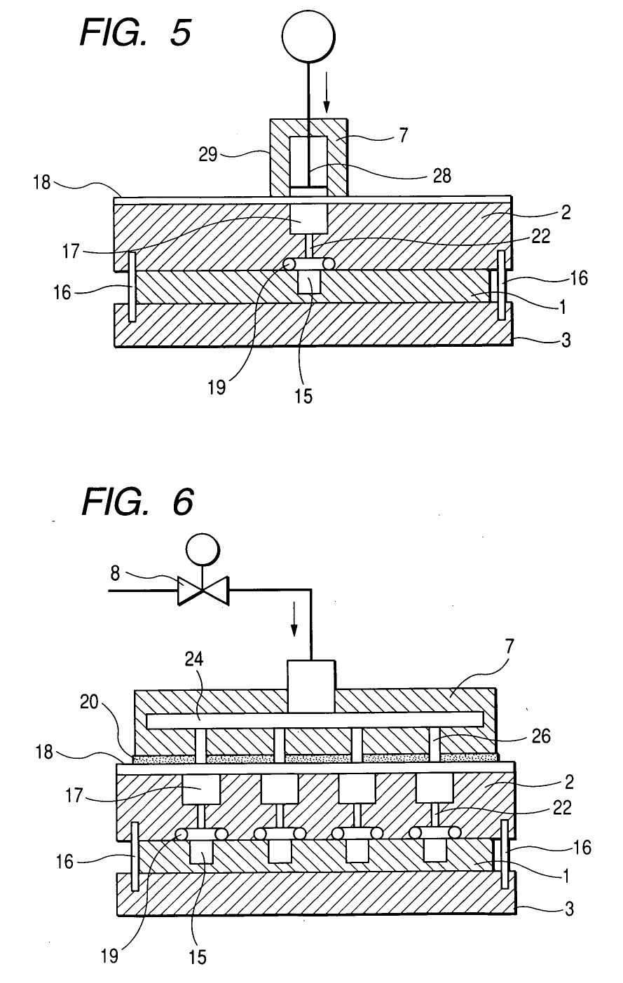

Next, a second embodiment of the present invention will be described with reference to FIG. 5. FIG. 5 is a vertical sectional view of a principal portion of a microfluid system according to a second embodiment of the present invention. This second embodiment is different in the following point from the first embodiment, but other points are basically the same as in the first embodiment.

In this second embodiment, the pressurizing portion 7 is constructed such that a piston 28 operates within a pressure cylinder 29 with use of air or electric power. Fluid present within the cylinder 29 is pressurized by operation of the piston 28, causing the flexible member 18 to operate, whereby the sample present within the sample server 17 is fed to the microchip inlet portion 15. The flexible member 18 may be omitted and instead the piston itself may be used as the flexible member.

A third embodiment of the present invention will be described below with reference to FIG. 6. FIG. 6 is a vertical sectional view of a principal portion of a microfluid system according to a third embodiment of the present invention. This third embodiment is different in the following point from the first embodiment, but other points are basically the same as in the first embodiment.

In this third embodiment, plural sets of sample inlet portions 15 are provided in the microchip body 1, plural sets of sample servers 17 are provided in the sample holder 2, and discharge ports 26 corresponding respectively to the sample servers 17 are provided in a single pressurizing portion 7. Channel inlet portions, microchip reaction vessel portions 14, and channel separating portions 13, are provided in the microchip body 1 correspondingly to the sample inlet portions 15. According to this embodiment, plural samples can be introduced at a time into the microchip body 1.

When the amounts of samples to be introduced are to be made different amounts, this can be attained by differentiating the diameters of the sample servers 17 or the amounts of samples distributed to the sample servers 17.

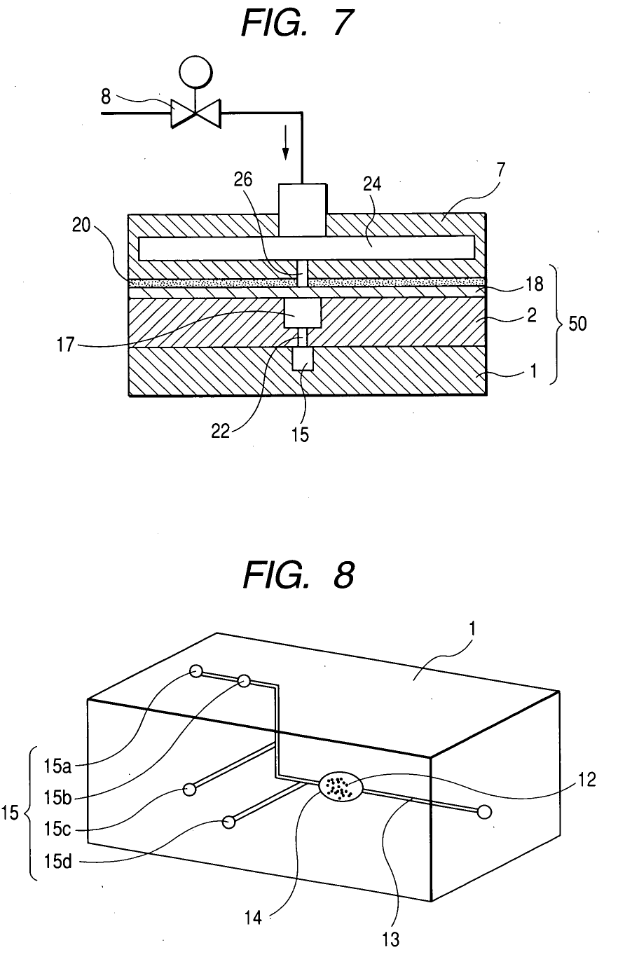

Next, a fourth embodiment of the present invention will be described below with reference to FIG. 7. FIG. 7 is a vertical sectional view of a principal portion of a microfluid system according to a fourth embodiment of the present invention. This fourth embodiment is different in the following points from the first embodiment, but other points are basically the same as in the first embodiment.

In this fourth embodiment, a microchip body 1 and a sample holder 2 are fabricated in a mutually bonded or united state, then after distribution of samples to sample servers 17, the flexible member 18 is installed, and all of these components are integrated into a microchip 50. According to this embodiment the microchip 50 can be handled extremely easily.

Next, a fifth embodiment of the present invention will be described below with reference to FIG. 8. FIG. 8 is a perspective view of a microchip body used in a microfluid system according to a fifth embodiment of the present invention. This fifth embodiment is different in the following points from the first embodiment, but other points are basically the same as in the first embodiment.

In this fifth embodiment, the microchip body 1 is constructed as a three-dimensional structure and plural pressurizing portions (not shown) opposed to plural microchip inlet portions 15 are provided to attain the reduction in size of the microchip body 1.

1. A microfluid system having a microchip for feeding plural samples to a treating portion and performing predetermined treatments,
wherein a plurality of sample servers for storage of the samples therein are provided in the microchip, the sample servers and the treating portion are connected with each other through capillary channels provided respectively on outlet sides of the sample servers, and a pressurizing device for pressurizing the samples stored in the sample servers and feeding the samples to the treating portion is provided.

2. The microfluid system according to claim 1, wherein the microchip is constituted by a microchip body and a sample holder in an up-and-down relation to each other, the treating portion is formed in the microchip body, and the sample servers are formed in the sample holder.

3. The microfluid system according to claim 1 or claim 2, wherein the capillary channels are formed so as to have a surface tension such that the samples stored in the sample servers do not flow out by their own weights.

4. The microfluid system according to claim 2, wherein a plurality of sample inlet portions for introducing samples from the sample servers, a channel inlet portion for introducing samples from the sample inlet portion to the treating portion, and a channel separating portion extending from the treating portion, are formed in the microchip body.

5. The microfluid system according to claim 1 or claim 2, wherein the pressurizing device comprises a flexible member for closing openings formed in the sample servers, the flexible member being brought into deformation into the sample servers to pressurize the samples.

6. The microfluid system according to claim 4, wherein the sample servers are provided so as to be open in an upper surface of the sample holder, and the flexible member is formed in the shape of a thin plate and is installed on the sample holder so that the flexible member can close and open the openings of the sample servers.

7. The microfluid system according to claim 5, wherein at least one of the microchip and the pressurizing device is made movable for separation from and close contact with each other.

8. The microfluid system according to claim 4, wherein the pressurizing device applies a fluid pressure to the flexible member on the side opposite to the sample servers, causing the flexible member to be deformed into the sample servers.

9. The microfluid system according to claim 2, wherein a positioning means is provided for positioning the sample holder and the microchip body so as to provide communication between the sample servers and the treating portion.

10. A microfluid system according to claim 2, wherein the treating portion and the sample servers are provided in plural sets.
